(19) United States
(12) Patent Application Publication
(10) Pub. No.: US 2009/0234895 A1
(43) Pub. Date: Sep. 17, 2009

(54) Method and Apparatus for Digitizing a Paper-Based Publication

(76) Inventor: Daniel Michael Paul Nugara, Wayne, IL (US)

Correspondence Address: VEDDER PRICE P.C., 222 N. LASALLE STREET, CHICAGO, IL, 60601, US

(21) Appl. No.: 12/049,876

(22) Filed: Mar. 17, 2008

(51) Int. Cl. G06F 12/00

(52) U.S. Cl. 707/203; 707/E17.001

(57) ABSTRACT

The present disclosure relates generally to a method and apparatus for the transformation of a community-based, paper-based publications or directories of a chamber of commerce into multiple versions, and more particularly, to publication of a database for cross-publication of digital versions of publications in a form such as a website, an eBook, and a mobile membership directory or any combination thereof. The method also discloses how data is collected and transformed by a first publisher and a second publisher in the different formats using a plurality of distribution methods to increase exposure to customers in the marketplace using a single visual interface.

### FIELD OF THE DISCLOSURE

The present disclosure relates generally to a method and apparatus for the transformation of a community-based, paper-based publication or directory of a chamber of commerce into one or multiple versions of the publication, and more particularly, to digital versions such as a website, an eBook, and a mobile membership directory or any combination thereof.

### BACKGROUND

Some types of associations or groups, such as Chambers of Commerce, municipalities, university campuses, etc., are formed from a network of individuals and/or corporate entities. In today's marketing environment, large conglomerates and franchises that operate nationwide have the resources to access the general press and audiovisual media in large-scale marketing campaigns. Smaller corporate entities, individuals, associations, and nonprofit groups must find ways to compete with these giants at minimal cost while reaching out to the largest client base possible. A first way is to resort to local press and audiovisual media, but this marketing method is relatively localized and has a relatively brief lifespan. A second way is to resort to proximity campaigns, such as word-of-mouth and community activism, but these methods are time consuming and require extensive manpower. A third way is the use of new technologies, such as the Internet and other digital media.

The Internet was initially believed to be an open, unobstructed window to the world, but it is now understood to be a clogged information highway. Much the same can be said for other digital media. In the early stages of marketing of the eBook, it was proclaimed that paper-based publications would soon be obsolete and as they were replaced by small, portable screens capable of displaying eBooks and eNewspapers. In the same vein, others believed that connecting cell mobiles to the Internet or providing wireless data exchange possibilities in handheld devices such as PDAs (Personal Digital Assistants) would automatically allow users to access and utilize information effortlessly. A greater understanding of the intricacies of these different technologies, which is only available in hindsight, has shown that early optimism to be unfounded. Websites, even in full operation, do not necessarily translate to sales, eBooks are simply not replacing paper-based publications, and wireless mobiles with data communication capacity are still mostly used as mobiles. New methods and apparatuses must be developed by inventors in the various digital markets to combine these technologies and create viable commercial models.

Chambers of Commerce, associations, and municipalities have operations that must also be addressed by technologies specifically tailored to their needs. Typically, these types of community-based entities are not as well-equipped as corporations to compete in the marketplace with strong, corporate marketing departments. The leadership of community based entities is often elected and changes periodically. Further, services provided to their electorate or members must be offered at a low cost. Directories and community-based information must constantly be updated and is subject to dynamic change as events take place and members come and go.

Historically, these groups have used annual or quarterly paper-based publications to coordinate directory services, tourism, local advertising, and event planning. U.S. patent application Ser. No. 10/208,476 to Brown describes how, at the height of the Internet boom, it was believed a community-based directory could radically move away from paper-based publication to interactive electronic services using an Internet website and a portable or wireless computer. With hindsight, it has become clear that while community-based websites have a global reach and can be updated regularly, they are often difficult to browse and cannot be handed out to tourists at a kiosk as marketing material. Brown is not directed to the transformation of a community-based directory used worldwide having different protocols of communication.

U.S. patent application Ser. No. 11/056,302 to Nugara et al. and owned by the Assignee of this invention reconciles historical methods of advertising with new methods. This invention understands tangible publications when used in tandem with new technologies using the Internet and a wireless mobile protocol, which can improve services substantially. U.S. patent application Ser. No. 11/056,302 describes how to create or collect directory-type information from a community and publish it using a novel method. U.S. patent application Ser. No. 11/464,646 also to Nugara, which is a continuation-in-part of Ser. No. 11/056,302, describes how publications can be in the form of eBooks or other tangible media.

Some communities and groups have already created publications containing a wide range of information, which are not limited to community-based directories. What is needed is a method and apparatus to enhance and improve the market presence of communities that already have some degree of market exposure.

### SUMMARY

The present disclosure relates generally to a method and apparatus for the transformation of a community-based, paper-based publications or directories of a chamber of commerce into a single or multiple versions, and more particularly, to publication of a database for cross-publication of digital versions of publications in a form such as a website, an eBook, and a mobile membership directory or any combination thereof. The method also discloses how data is collected and transformed by a first publisher and a second publisher in the different formats using a plurality of distribution methods to increase exposure to customers in the marketplace using a single visual interface.

### BRIEF DESCRIPTION OF THE DRAWINGS

Certain embodiments are shown in the drawings. However, it is understood that the present disclosure is not limited to the arrangements and instrumentality shown in the attached drawings, wherein:

FIG. 1 is a general functional diagram of the method and apparatus to digitize a paper-based publication and distribute the digital version into the marketplace according to an embodiment of the present disclosure.

FIG. 2 is a detailed diagram illustrating the different data transfers within the method and apparatus to digitize a paper-based publication as shown in FIG. 1.

FIG. 3 is a functional block diagram of the different steps of the method shown in FIGS. 1-2 according to an embodiment of the present disclosure.

FIG. 4 is a functional block diagram of a computer-embodied apparatus for the digitalization of a paper-based publication for a community-based group according to another embodiment of the present disclosure.

### DETAILED DESCRIPTION

The present invention is not limited to the particular details of the apparatus and method depicted, and other modifications and applications may be contemplated. Further changes may be made in the above-described device and method without departing from the true spirit and scope of the invention herein involved. It is intended, therefore, that the subject matter in the above depictions should be interpreted as illustrative, not in a limiting sense. It is understood by one of ordinary skill in the art that these different elements correspond to the general elements found in this disclosed system to practice this disclosure. Other auxiliary elements and limitations may be imagined and contemplated to operate the device and method, but they do not affect the validity and completeness of the disclosure of this device and method.

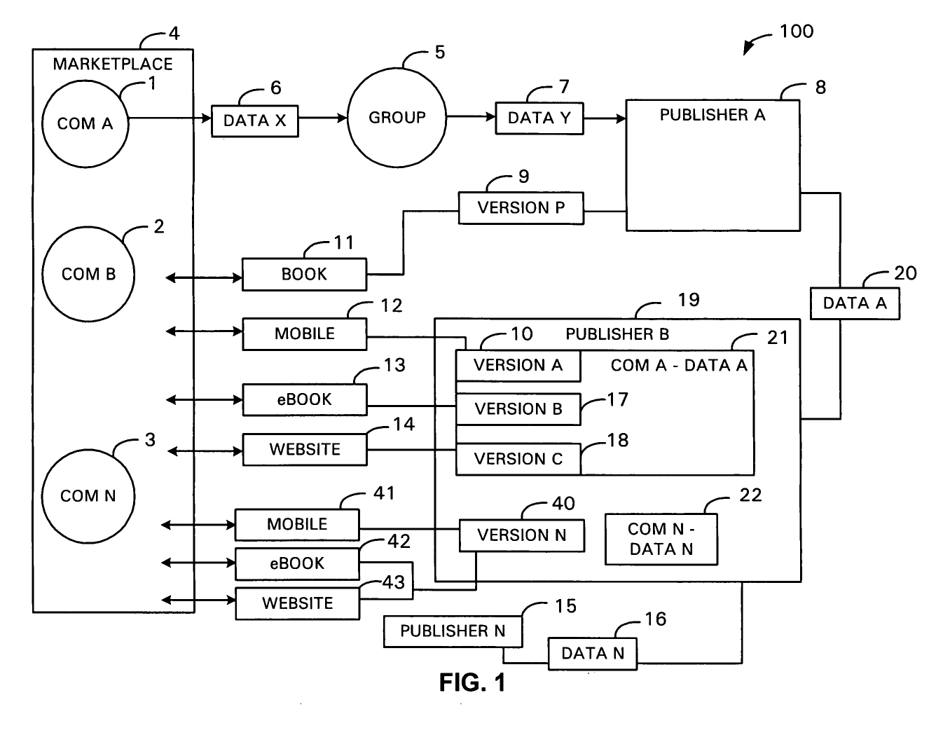

FIG. 1 is a general functional diagram of the method 100 and apparatus to digitize and release a paper-based publication in the marketplace. A first community 1, shown as COM A, is made of individuals, corporations, partnerships, associations, and the like, which may be associated as a group 6 based on goods, services, a location, or even a common goal such as, by way of nonlimiting example, the preservation of local landmarks or a forming a Chamber of Commerce. This group 6 assembles or collects data shown as Data X 6 directed to the subject matter linked with the group 6. From this first set of Data X 6, the information is assembled, organized, and focused to a useful set of Data Y before it is given to a first Publisher A 8 needed to create a paper-based publication shown as Version P 9 of a book 11. The Publisher A 8 edits and modifies the Data Y 7 into a first set of data 20 shown as Data A associated with the paper-based publication Version P 9 and ultimately the book 11. The book 11 is then distributed in the marketplace 4, which is a general marketplace that includes the first community 1 shown as COM A, a second community 2 shown as COM B, and even a third community 3 shown as COM N. The use of the letter N indicates to one of ordinary skill in the art that while three communities 1, 2, 3 are shown, what is contemplated is the existence in the marketplace 1 of a plurality of N communities formed from the same or different individuals or legal entities based on their different interests.

Previously, once created, the book 11 is updated at regular time intervals or may be part of a periodical publication. Each time the book 11 is updated, a new or revised set of Data X 6, Data Y 7, and Data A 7 is created alongside the Version P 9. In some cases (not shown), the group 5 can mandate Publisher A 8 to create the first set of Data A 20 directly from Data X 6. The advantages associated with tangible publications are described in U.S. application Ser. Nos. 11/056,302 and 11/464,646 to Nugara et al. These applications are fully incorporated herein by reference.

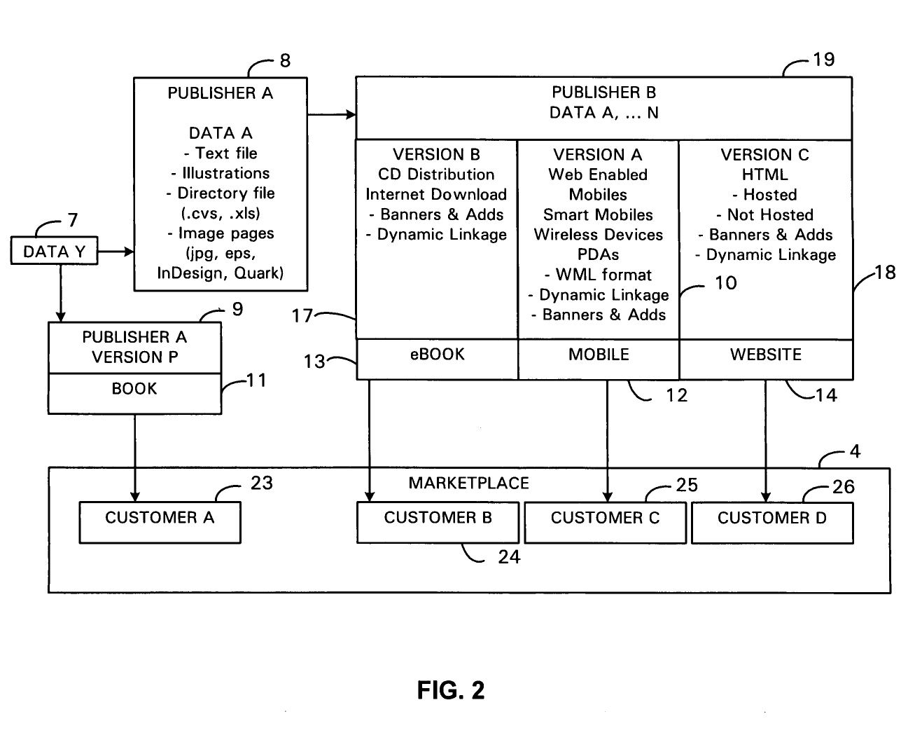

FIG. 1 shows a new method of digitizing a paper-based publication for a community based group 100 where Data A 20, which is a first set of data, is requested from a first publisher 8. This first set of data 20 is created by the first Publisher 8 from an initial set of marketplace data shown as Data X 6 representative of a first community 1 as modified by a first group 5 associated with the first community 1 into an intermediate set of data 7 also shown as Data Y used to create the paper-based publication 11. FIG. 2 is a detailed diagram illustrating the different data transfers within the method and apparatus to digitize a paper-based publication. The first set of data 20 associated with the first Publisher 8 may include a text file, a series of illustrations, and a directory file in any known format. In a preferred embodiment, the directory file is in a .cvs or .xls file format. In another contemplated embodiment, the first set of data 20 can be associated with images in common file formats (e.g., jpg, .eps, .tiff, InDesign, or Quark).

Returning to FIG. 1, a second publisher 19, shown as Publisher B, associates the Data A 20 in a database 21 as the first set of data with the first community shown as COM A—DATA A. The first set of data 20 is then archived in the database 21 alongside with a plurality of at least one other existing set of data 16 of another community from the marketplace shown as COM N—DATA N. Once again, the use of the letter N is used to signify a plurality of at least one other element where N is often a very large number. What is also shown in FIG. 1 is how the Data A can be taken from a first Publisher A 8, but also from another Publisher N 15 with a transfer of Data N 16. What is also contemplated is a situation where the first publisher 8 and the second publisher 19 are the same or different entities of the same corporate structure in a media corporation.

What is shown is the creation 10, 17, 18 and publication 12, 13, 14 of a mobile-usable version 10, 12 of the first set of data 20 and storing the mobile-usable version in a mobile-readable format in the database 21 of the second publisher 19 alongside the first set of data 20. In addition, what is shown is the creation 17 and publication 13 of an eBook version of the first set of data 20 and storing the eBook version 17 in an eBook format in the database 21 of the second publisher 19 alongside the first set of data 20. Also, what is shown is the creation 18 and publication 14 of a website version of the first set of data 20 and storing the website pages as a website version 18 in a browser-readable format such as HTML in the database 21 of the second publisher 19 alongside the first set of data 20.

What is also shown is the creation 40 and publication of a mobile-usable version 41, an eBook version 42, and a website version 43 of the at least one other existing sets of data 16 from another community 3 from the marketplace 4. In a subsequence step, access is provided to a user from the marketplace 4 with a mobile to the mobile-usable version 12 of the first set of data 20 and to the at least one other mobile-usable version 41 of an existing set of data 16 from another community 3 via telephonic communication.

Returning to FIG. 2, the second publisher 19 is shown with a plurality of data (Data A, . . . N). The mobile-usable version 10 of the first set of data 20 is created in a format that is accessible by web-enabled mobiles, smart mobiles, wireless devices, personal data assistant devices, and iPhones in a plurality of formats including wml format. What is also contemplated is the use of dynamic linking or banners and advertisements to further enhance the mobile-usable version 10 of the first set of data 20. The use of dynamic links in the chosen file format, along with other dynamic systems, allows for greater facility in browsing and accessing information within the mobile-usable version 10. What is contemplated is the use of any use or function supported by the different programming languages of mobile-based devices described herebefore to enhance the use of the first set of data 20.

What is shown in FIG. 2 is the existence of Customers A 23, B 24, C 25, and D 26 in the marketplace 4. To increase the market presence of the first set of data 20, a plurality of digitized versions 10, 17, 18 are released and published 12, 13, 14 in the marketplace 4. Different customers, readers, or users may desire or have access to different versions using different technological access points. By increasing the different vectors of communication, what is increased is the overall market presence. In the area of publications of Chambers of Commerce, for example, the choice of an eBook, a printed book, a mobile-readable version, and a website version is particularly desirable when associated with diverse communities. Communities such as Chambers of Commerce, unlike the general population, have specific needs that often relate to providing information with the desire to increase marketplace presence and sales, and thus profitability, of the different members of the group 6. It has been found by Applicant that a website version, a mobile-readable version, and an eBook by themselves or in combinations of two are not sufficiently useful and desirable to Chambers of Commerce that desire to make information available to the marketplace via different media. For example, CDs are created and distributed along with a possible Internet download for the eBook 13 made from the first set of data 20. By providing a user with a copy of the eBook 13 in addition to the printed book 11, and by providing access to a mobile-readable version 12 and a website version 14, the publisher increases the market impact of the first set of data 20 and users can be provided access via a database 21 to other sets of data 16 that relate to other communities 3.

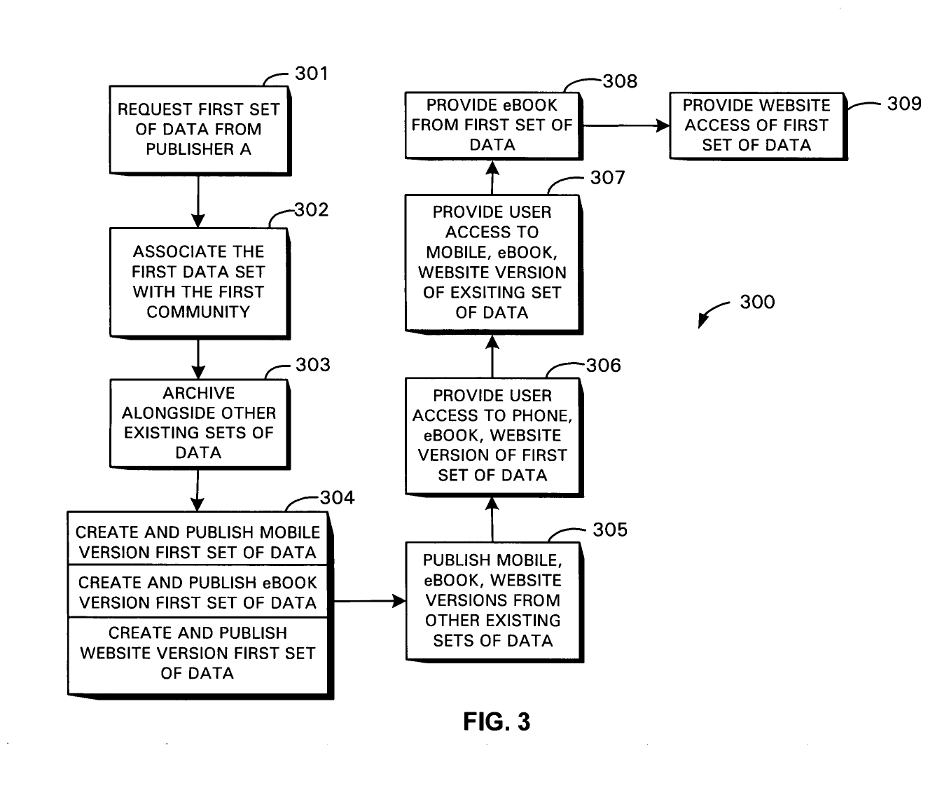

The method includes providing to a second user from the marketplace 4 a copy of the eBook 13 made from the first set of data 20 and providing to a third user from the marketplace access to the website version 14 of the first set of data 20, as well as to the at least one other website 43 of the at least one other existing set of data 22 from another community 3. By adding banners and ads to the mobile-usable version 12, the eBook version 13, and the website version 14 of the first set of data 20 before publication and the existing set of data 16 from another community 3, the method is further improved. In other embodiments, dynamic links are added to the mobile-usable version 12, the eBook version 13, and the website version 14 of the first set of data 20 and the existing set of data 16 from another community 3. The method also contemplates providing only part of the information to users, namely only a first version, a second version, and a third version of the first set of data 20 and a parallel version of the other existing set of data, or any dual or triple combination thereof as shown on FIG. 3.

In another contemplated embodiment, the book or paper-based publication 11 includes a graphical interface or a typeset and wherein the mobile-usable version 12 of the first set of data 20, the eBook version 13 of the first set of data 20, and the website version 14 of the first set of data 20 includes the graphical interface. For example, if the book 11 has a purple typeface, what is contemplated is the use of this typeface to enhance the different digital versions made from the first set of data 20. In yet another embodiment, the first set of data 20 further includes a directory file in a table format if the paper-based publication includes a community directory.

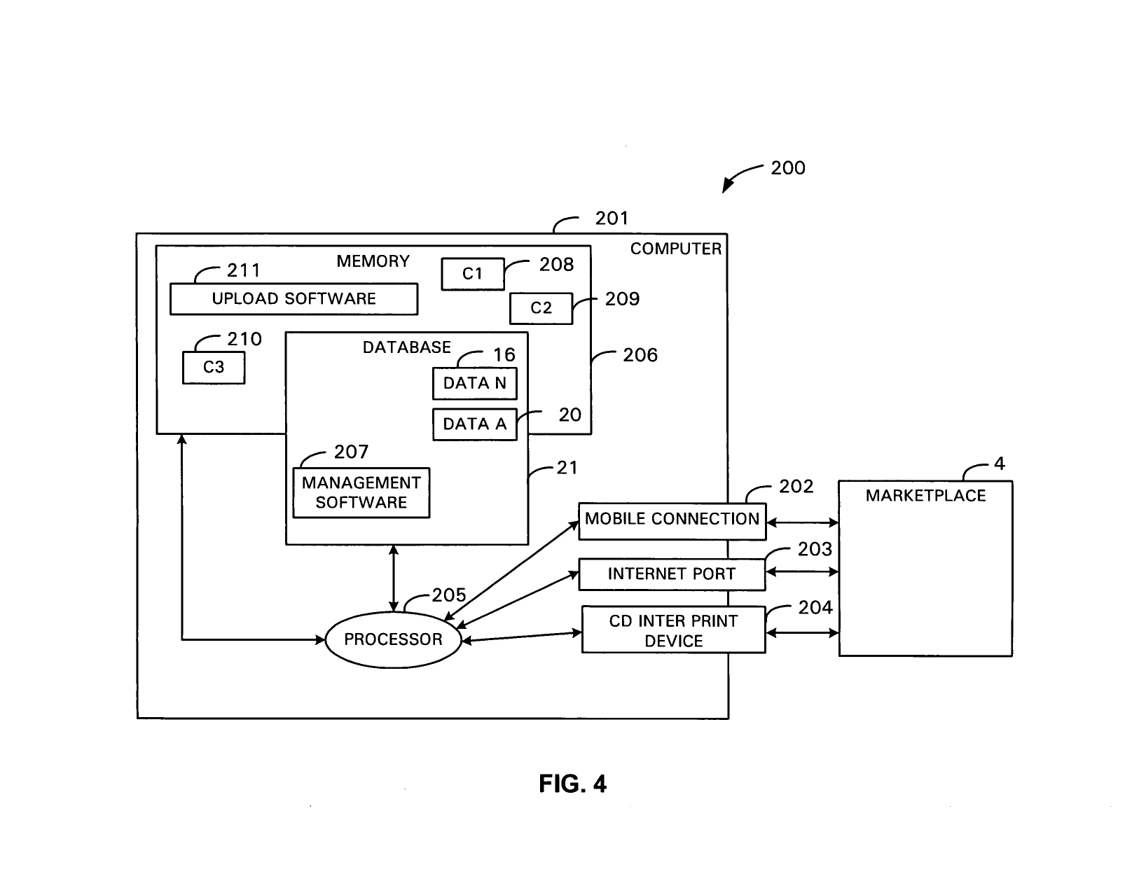

FIG. 4 shows a computer-embodied apparatus 200 for the digitizing of a paper-based publication for a community-based group including an uploading software 211 stored in a memory 206 of a computer 201 with a processor 205 and functional access to an Internet connection 203 such as an Internet port, a wireless mobile connection 202, a database 21 in the memory 206, and a compact disk printing device 204. What is disclosed is the use of any type of computer system having an operating system capable of operating software via a processor and memory. In one embodiment, the compact disk printing device 204 is a disk burner connected to the computer by a connection port. The uploading software 211 is designed to upload into the database a first set of data 20 from a first community, a database management software 207 operating the database 21 for storing the first set of data 20 from the first community (not shown in FIG. 4), and at least a second set of data 16 from a second community.

What is also contemplated is the use of a first creation software C1 as 208 for creating from the first set of data 20 from the database 21 through the database management software 207 a mobile-usable version as shown in FIG. 1, a second creation software C2 as 209 for creating from the first set of data 20 from the database 21 through the database management software 207 an eBook version as shown in FIG. 1, and a third creation software C3 as 210 for creating from the first set of data 20 from the database 21 through the database management software 207 a website version as shown in FIG. 1. One of ordinary skill in the art recognizes how memory 206 operates in tandem with software 208, 209, 210, 211, 207 and the database 21 in order to transform the data 16, 20 into the various usable versions through the processor 205.

A publishing software 212 for publishing on the Internet via the Internet connection 203 publishes the website version of the first set of data 20 and a website version of the second set of data 16 as shown in FIG. 1. The publishing software 212 also publishes over a mobile network via the wireless mobile connection 202 the mobile-usable version, and for burning hard copies of the digital file forming an eBook version of the first set of data 20 using the compact disk printing device 204. What is also disclosed is allowing a download from the memory 206 via the Internet connection of the eBook version as shown in FIG. 1. What is shown in FIG. 4 is the embodiment of the different software and hardware, not the different functions associated with the transfer and processing of the information associated with the different publications as shown and described above and incorporated fully in the apparatus claim.

Persons of ordinary skill in the art appreciate that although the teachings of the disclosure have been illustrated in connection with certain embodiments, there is no intent to limit the invention to such embodiments. On the contrary, the intention of this application is to cover all modifications and embodiments falling fairly within the scope of the teachings of the disclosure.

What is claimed is:

1. A method of digitizing a paper-based publication for a community-based group, the method comprising the steps of:
requesting from a first publisher a first set of data associated with a paper-based publication created by the first publisher from an initial set of marketplace data representative of a first community as modified by a first group associated with the first community into an intermediate set of data used to create the paper-based publication, wherein said first set of data includes a text file and a series of illustrations;
associating in a database of a second publisher the first set of data with the first community;
archiving in the database of the second publisher the first set of data alongside a plurality of at least one other existing set of data of another community from the marketplace;
creating and publishing a first version of the first set of data and storing the first version in a first format in the database of the second publisher alongside the first set of data; and
publishing a parallel version of the at least one other existing sets of data from another community from the marketplace;
providing access to a user from the marketplace to the first version and the parallel version.

2. The method of digitizing a paper-based publication for a community-based group of claim 1, further comprising the steps of creating and publishing a second version of the first set of data, storing the second version in a second format in the database of the second publisher alongside the first set of data, and providing access to the user to the first, the second and the parallel version.

3. The method of digitizing a paper-based publication for a community-based group of claim 2, further comprising the steps of creating and publishing a third version of the first set of data and storing the third version in a third format in the database of the second publisher alongside the first set of data, and providing access to the user to the first, the second, the third and the parallel version.

4. The method of digitizing a paper-based publication for a community-based group of claim 2, wherein the first version is a mobile-usable version of the first set of data and storing the first version in a mobile-readable format in the database of the second publisher alongside the first set of data, and the second version is a website version of the first set of data and storing the second version in a browser-readable format in the database of the second publisher alongside the first set of data.

5. The method of digitizing a paper-based publication for a community-based group of claim 2, wherein the first version is an eBook version of the first set of data and storing the first version in an eBook format in the database of the second publisher alongside the first set of data, and the second version is a website version of the first set of data and storing the second version in a browser-readable format in the database of the second publisher alongside the first set of data.

6. The method of digitizing a paper-based publication for a community-based group of claim 2, wherein the first version is a mobile-usable version of the first set of data and storing the first version in a mobile-readable format in the database of the second publisher alongside the first set of data, and the second version is an eBook version of the first set of data and storing the second version in an eBook format in the database of the second publisher alongside the first set of data.

7. The method of digitizing a paper-based publication for a community-based group of claim 3, wherein the first version is a mobile-usable version of the first set of data and storing the first version in a mobile-readable format in the database of the second publisher alongside the first set of data, and the second version is an eBook version of the first set of data and storing the second version in an eBook format in the database of the second publisher alongside the first set of data, and the third version is a website version of the first set of data and storing the third version in a browser-readable format in the database of the second publisher alongside the first set of data.

8. The method of digitizing a paper-based publication for a community-based group of claim 7, further comprising the steps of publishing a mobile-usable version, an eBook version, and a website version of the at least one other existing sets of data from another community from the marketplace; providing access to a user from the marketplace with a mobile to the mobile-usable version of the first set of data, and to the at least one other mobile-usable version of an existing set of data from another community via telephonic communication; providing to a second user from the marketplace a copy of the eBook made from the first set of data; and providing to a third user from the marketplace access to the website version of the first set of data, and to the at least one other websites of the at least one other existing set of data from another community.

9. The method of claim 8, wherein the method further comprises the steps of:
adding banners and advertisements to the mobile-usable version, the eBook version, and the website version of the first set of data before publication and the existing set of data from another community; and adding dynamic links to the mobile-usable version, the eBook version, and the website version of the first set of data and the existing set of data from another community.

10. The method of claim 9, wherein the first set of data further includes a directory file in a table format if the paper-based publication includes a community directory.

11. The method of claim 9, wherein the first set of data further includes image pages in .jpg, .ceps, .tiff, InDesign, or Quark formats.

12. The method of claim 9, wherein the paper-based publication includes a graphical interface and wherein the mobile-usable version of the first set of data, the eBook version of the first set of data, and the website version of the first set of data includes the graphical interface.

13. The method of claim 9, wherein the eBook version of the first set of data is distributed on a compact disk.

14. The method of claim 9, wherein the eBook version of the first set of data is downloadable from the Internet at the website version of the first set of data.

15. A computer-embodied apparatus for the digitization of a paper-based publication for a community based group, comprising:
an uploading software stored in a memory of a computer with a processor and a functional access to an Internet connection, a wireless mobile connection, a database in the memory, and a compact disk printing device, the uploading software designed to upload into the database a first set of data from a first community;
a database management software operating the database for storing the first set of data from the first community and at least a second set of data from a second community;
a first creation software for creating from the first set of data from the database through the database management software a mobile-usable version;
a second creation software for creating from the first set of data from the database through the database management software an eBook version;
a third creation software for creating from the first set of data from the database through the database management software a website version; and
a publishing software for publishing on the Internet via the Internet connection the website version of the first set of data and a website version of the second set of data, for publishing over a mobile network via the wireless mobile connection the mobile-usable version, and for burning hard copies of the eBook version of the first set of data using the compact disk printing device, and allowing a download from the memory via the Internet connection of the eBook version.
